(19) United States
(12) Patent Application Publication
(10) Pub. No.: US 2010/0243528 A1
(43) Pub. Date: Sep. 30, 2010

(54) METHOD AND SYSTEM RELATING TO A WET GAS COMPRESSOR

(76) Inventors: Leonard E. Bell, Elgin, IL (US); Keith Allen Couch, Arlington Heights, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/414,358

(22) Filed: Mar. 30, 2009

(51) Int. Cl. C10G 11/00; B01J 19/00

(52) U.S. Cl. 208/113; 422/139

(57) ABSTRACT

One exemplary embodiment can be a method for revamping a fluid catalytic cracking unit. The method can include communicating an expander powered by a regeneration zone flue gas stream with a wet gas compressor transferring a stream including one or more hydrocarbons from a receiver of the fluid catalytic cracking unit.

### FIELD OF THE INVENTION

This invention generally relates to fluid catalytic cracking, and more particularly, to a wet gas compressor in a fluid catalytic cracking system or unit.

### DESCRIPTION OF THE RELATED ART

Generally, a fluid catalytic cracking (hereinafter may be abbreviated “FCC”) unit can include at least one compressor for transferring one or more gases. Often, an FCC unit can be modified to increase production. In such an instance, it is often desired to revamp an existing unit and utilize resources efficiently. One such resource can be the flue gas stream exiting the regenerator. Often, the energy from this stream can be captured to run other equipment, such as the main gas compressor, providing air to the FCC regenerator. Particularly, the proximity of the main gas compressor to the flue gas outlet of the regenerator can make such a modification desirable.

Unfortunately, modifying the main gas compressor to include equipment, such as an expander, to capture this stream can be expensive. Usually, the main gas compressor is relatively large, and an expander of a suitable size can require a corresponding large capital outlay. Moreover, the main gas compressor may require much of the energy of the flue gas stream to operate. As such, there is little or no excess energy for use in other operations or utilities. Therefore, there would be a benefit for identifying other uses for the flue gas stream for providing flexibility of running equipment or generating utilities.

### SUMMARY OF THE INVENTION

One exemplary embodiment can be a method for revamping a fluid catalytic cracking unit. The method can include communicating an expander powered by a regeneration zone flue gas stream with a wet gas compressor transferring a stream including one or more hydrocarbons from a receiver of the fluid catalytic cracking unit.

Another exemplary embodiment may be a system for operating a wet gas compressor. The system can include an expander receiving a flue gas from a regeneration zone of a fluid catalytic cracking unit, and a wet gas compressor transferring a stream comprising one or more hydrocarbons. The expander can communicate with the wet gas compressor for at least intermittently powering the wet gas compressor.

Yet another exemplary embodiment can be a system for utilizing a regeneration zone flue gas. The system may include a wet gas compressor, a dynamotor, an expander, and a split gear. Generally, the expander receives the regeneration zone flue gas for powering at least one of the wet gas compressor and the dynamotor. The split gear can communicate the expander with the wet gas compressor and the dynamotor.

Thus, the embodiments as disclosed herein can allow for the reduction in capital costs by modifying a wet gas compressor as opposed to a main gas blower. Particularly, the wet gas compressor tends to be smaller than a main gas blower. Modifying the wet gas compressor can require less capital expenditure, such as for a corresponding expander, as a main gas blower. Thus, making the wet gas compressor modification can be a more attractive alternative. Moreover, the wet gas compressor can have lower energy requirements, permitting excess energy to be used to generate utilities, such as electricity. Modifying the wet gas compressor can provide opportunity to not only operate equipment, but to generate electricity as well, which may be a more desired activity during some economic conditions. Hence, the embodiments disclosed herein can provide a net power producer with operational flexibility rather than a consumer of electricity.

### DEFINITIONS

As used herein, the term “stream” can be a stream that may include one or more fluids, such as various hydrocarbon molecules, including straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “substantially” can mean an amount of generally at least about 80%, preferably about 90%, and optimally about 99%, by mole, of a compound or class of compounds in a stream.

### BRIEF DESCRIPTION OF THE DRAWINGS

FIG. 1 is a schematic depiction of an exemplary fluid catalytic cracking unit or system.

FIG. 2 is a schematic depiction of an exemplary fluid transfer device.

FIG. 3 is a schematic depiction of another exemplary fluid transfer device.

FIG. 4 is a schematic depiction of yet another exemplary fluid transfer device.

FIG. 5 is a schematic depiction still another exemplary fluid transfer device.

FIG. 6 is a schematic, front elevational view of an exemplary split gear.

FIG. 7 is a schematic depiction of a further exemplary fluid transfer device.

FIG. 8 is a schematic depiction of yet a further exemplary fluid transfer device.

### DETAILED DESCRIPTION

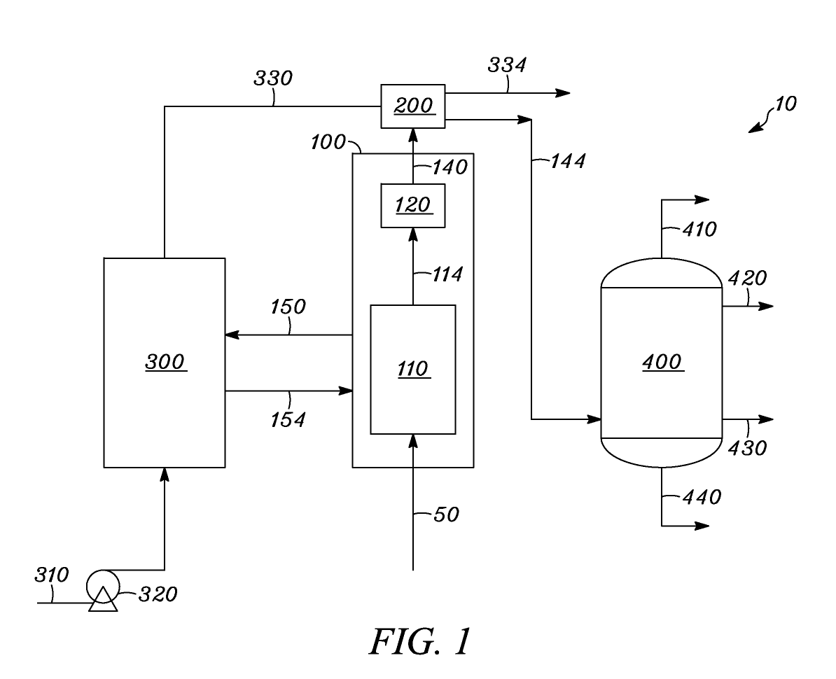

Referring to FIG. 1, a fluid catalytic cracking unit or system 10 can include a reaction zone 100, a fluid transfer device 200, a regeneration zone 300, and a product separation zone 400. Typically, a fluid catalytic cracking feed 50 can enter the reaction zone 100, which can be a riser reactor, and be reacted. The reaction zone 100 can include a reactor 110 and a receiver 120, which can collect a reactor effluent 114 that may include one or more overhead gases and optionally one or more suspended liquids from the reactor 110. A stream 140 including one or more hydrocarbons can exit the reaction zone 100 and be received by the fluid transfer device 200, as hereinafter described. Typically, the stream 140 includes one or more C10⁻ hydrocarbons, such as C2-C10 hydrocarbons. Usually, the reaction zone 100 provides spent catalyst through a line 150 to the regeneration zone 300 and receives regenerated catalyst through a line 154. Exemplary reaction zones and regeneration zones are disclosed in, e.g., U.S. Pat. No. 4,090,948 and U.S. Pat. No. 7,312,370 B2.

The regeneration zone 300 can receive a stream 310 including substantially air that is compressed in a main compressor 320 before being provided to the regeneration zone 300. Typically, the main compressor 320 can be located proximate to the regeneration zone 300. Generally, the regeneration zone 300 utilizes the air stream 310 to burn off deposits from the catalyst. Afterwards, a regeneration zone flue gas stream 330 can exit the regeneration zone 300 and be received by the fluid transfer device 200. An outlet stream 334 can exit the fluid transfer device 200.

The fluid transfer device 200 can provide a compressed stream 144 including one or more hydrocarbons. This stream 144 can be received by the product separation zone 400. Particularly, various separation devices, such as one or more distillation columns, can provide different streams, such as a fuel gas stream 410, a liquid product gas 420, a light naphtha 430, and a heavy naphtha 440. An exemplary separation zone is disclosed in, e.g., U.S. Pat. No. 3,470,084.

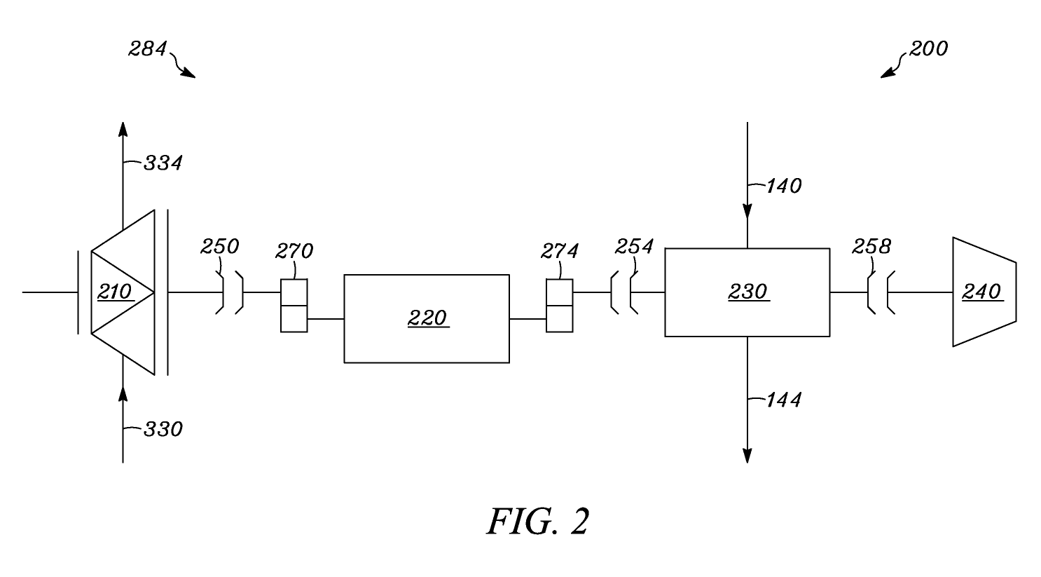

The fluid transfer device 200 can include an axial or centrifugal machine and be turbine or motor driven. Typically, the fluid transfer device 200 may not be positioned proximate to the regeneration zone 300. To minimize piping, it may be desirable to relocate the fluid transfer device 200 proximate to the regeneration zone 300 during a revamping of the fluid catalytic cracking unit 10. Similarly, it may be desirable to design a new fluid catalytic cracking unit 10 with the fluid transfer device 200 proximate to the regeneration zone 300 to minimize piping. The fluid transfer device 200 can include several components oriented in various configurations. Referring to FIG. 2, an exemplary fluid transfer device 200 can include an expander 210, a dynamotor 220, a wet gas compressor 230, and a turbine 240, which can be aligned in a series relationship 284.

Generally, the expander 210 lowers the pressure of a gas and extracts usable work from the process. In this exemplary embodiment, the expander 210 can extract work from a regeneration zone flue gas stream 330 having a large molar flow at a slight pressure differential. Typically, the expander 210 can receive a regeneration zone flue gas stream 330 that exits the outlet stream 334. Typically, the stream 330 can be at temperature of about 640-about 850° C., preferably about 680-about 730° C., and a pressure of about 300-about 400 kPa, preferably about 330-about 370 kPa. The outlet stream 334 can be at a temperature of about 540-about 640° C., preferably about 610-about 630° C., and at a pressure of about 110-about 140 kPa, and preferably about 115-about 125 kPa. The expander 210 can be incorporated into an existing design or included in a revamp unit to communicate with the dynamotor 220.

The dynamotor 220 can be used as both an electric motor and an electric generator. In this exemplary embodiment, the expander 210 may communicate through a first clutch 250 and a first gear 270 with the dynamotor 220. Typically, the expander 210 provides mechanical energy that can be transferred by the dynamotor 220 into mechanical energy and/or electricity. Particularly, the dynamotor 220 can, in turn, communicate with the wet gas compressor 230 via a second gear 274 and a second clutch 254. Excess energy can be converted into electricity. Alternatively, excess gas from the regeneration zone flue gas stream 330 can be bypassed around the expander 210 to lower power delivery to the wet gas compressor 230.

The wet gas compressor 230 can receive the stream 140 including one or more hydrocarbons and provide a compressed outlet stream 144 for communicating with the separation zone 400. The wet gas compressor 230 can also, in turn, communicate with a turbine 240, which can be powered by steam or electricity, via a third clutch 258. Typically, the stream 140 is at a temperature of about 20-about 30° C. and a pressure of about 100-about 250 kPa. The stream 140 can be compressed to provide the stream 144 at a temperature of about 30-about 110° C. and a pressure of about 500-about 1,400 kPa. In one preferred embodiment, the stream 144 can be at a temperature of about 100° C. and a pressure of about 550 kPa.

The fluid transfer device 200 can be started utilizing the turbine 240. Generally, the turbine 240 can be used either to start-up the wet gas compressor 230 or be used as a backup should the expander 210 be inoperable or provide insufficient energy. Particularly, the second clutch 254 can be disengaged with the dynamotor 220 and the third clutch 258 may be engaged with the wet gas compressor 230 to initially communicate the wet gas compressor 230 with the turbine 240. Generally, after the wet gas compressor 230 is started via the turbine 240, the expander 210 can be communicated with the dynamotor 220 by engaging the first clutch 250. In turn, the dynamotor 220 can then be communicated with the wet gas compressor 230, and the third clutch 258 can be disengaged interrupting the communication between the wet gas compressor 230 and the turbine 240. Typically, the dynamotor 220 can provide mechanical energy to drive the wet gas compressor 230, and excess mechanical energy can be converted to electricity and provided to the electrical grid in the refinery or chemical manufacturing facility. Alternatively, some of the flue gas 330 may be bypassed around the expander 210 to reduce its output to that of the wet gas compressor 230 demand.

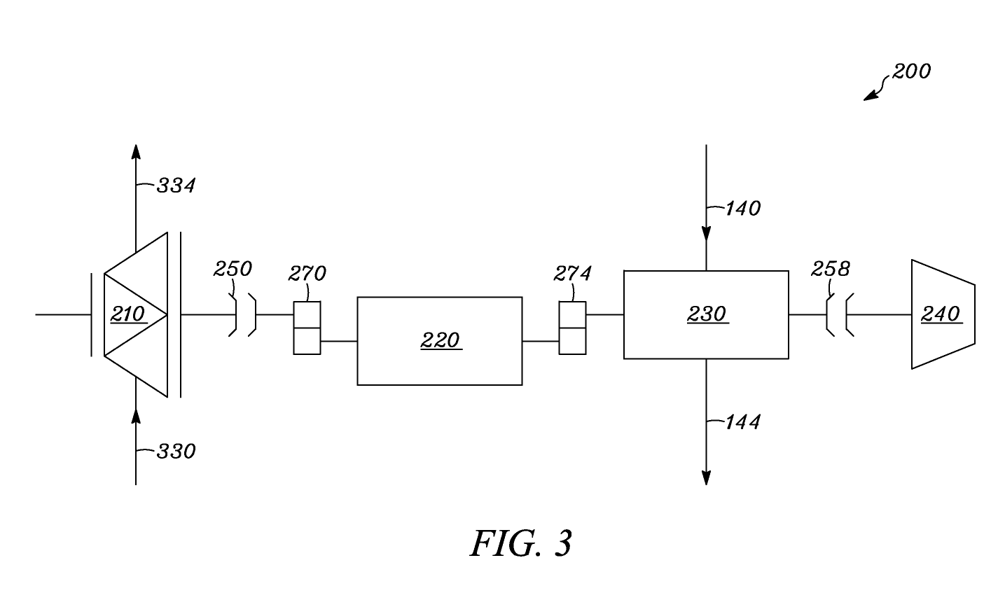

Referring to FIG. 3, another exemplary fluid transfer device 200 is depicted. This device is substantially similar to the version depicted in FIG. 2, except the second clutch 254 is omitted. Particularly, the dynamotor 220 may remain in continuous contact with the wet gas compressor 230. So during start-up, the turbine 240 can be engaged via the third clutch 258 with the wet gas compressor 230. When the turbine 240 is utilized during start-up, the wet gas compressor 230 can be in communication with the dynamotor 220. Simultaneously, the first clutch 250 can be disengaged until the wet gas compressor 230 is started. Afterwards, the first clutch 250 can become engaged to communicate the expander 210 with the dynamotor 220 and the wet gas compressor 230, and the third clutch 258 can be disengaged.

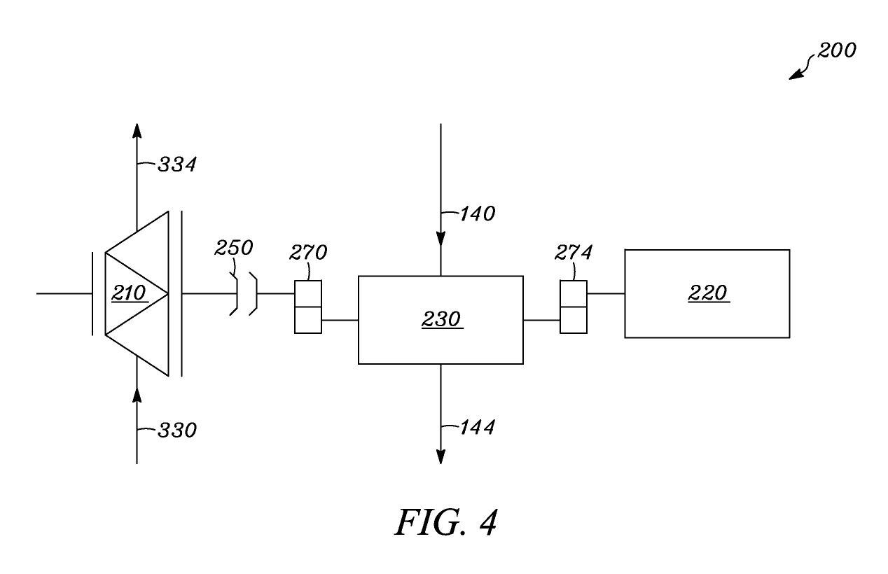

Referring to FIG. 4, yet another version of the fluid transfer device 200 is depicted. The fluid transfer device 200 can include the expander 210, the wet gas compressor 230, and the dynamotor 220. In this exemplary embodiment, the expander 210 can communicate with the wet gas compressor 230 via the first clutch 250 and the first gear 270. In turn, the wet gas compressor 230 may communicate with the dynamotor 220 via a second gear 274. In this exemplary embodiment, the expander 210 can provide the mechanical energy to the wet gas compressor 230 via the first clutch 250 and the first gear 270. Excess power can be routed via the second gear 274 to the dynamotor 220. In this exemplary embodiment, the dynamotor 220 can be connected to an electrical grid to provide electricity. In addition, the dynamotor 220 can also be connected to the grid to provide start-up power to the wet gas compressor 230 via the second gear 274. During start-up, the first clutch 250 can be disengaged to disconnect the wet gas compressor 230 from the expander 210.

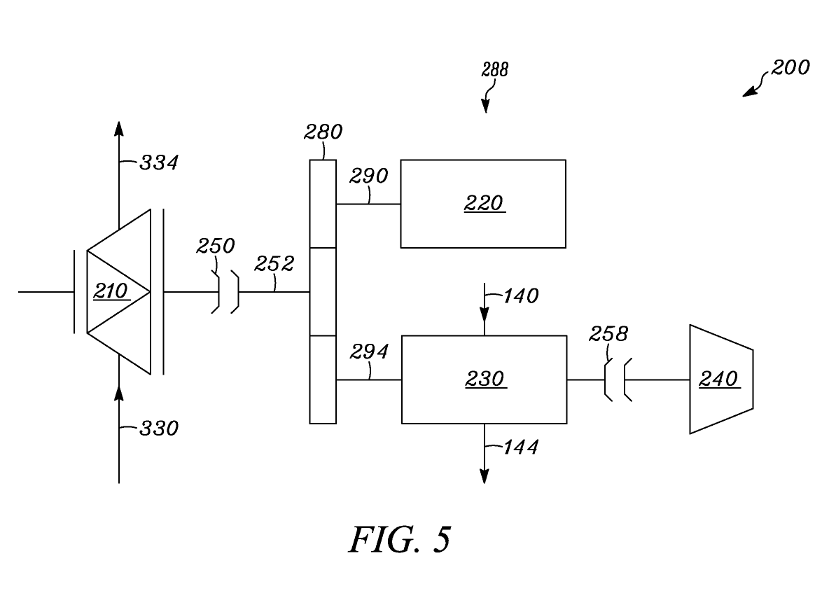

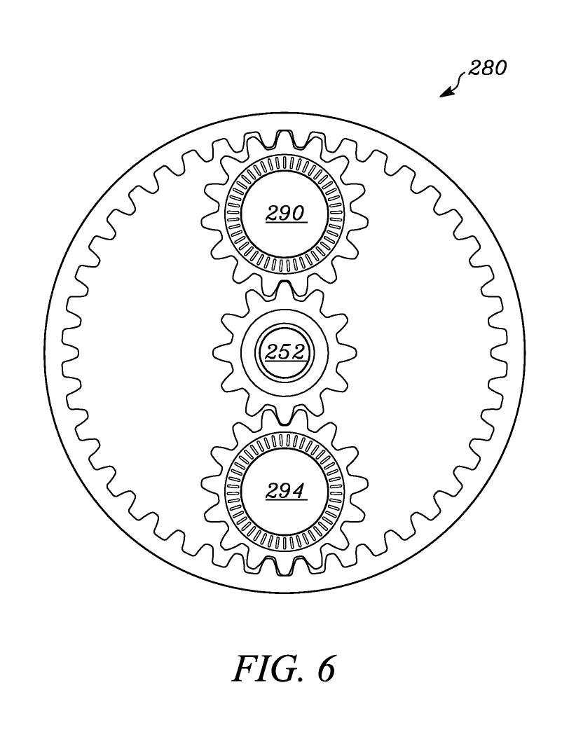

Referring to FIGS. 5-6, still another version of the fluid transfer device 200 is depicted. In this exemplary device 200, the expander 210 can communicate via the first clutch 250 and a shaft 252 with a split gear 280. The split gear 280 can, in turn, communicate via a shaft 290 and a shaft 294 with, respectively, the dynamotor 220 and the wet gas compressor 230. As such, the dynamotor 220 and the wet gas compressor 230 can be in a parallel relationship with respect to the expander 210. In addition, the wet gas compressor 230 can communicate with the turbine 240 via a third clutch 258. The split gear 280 may allow the expander 210 to simultaneously communicate with the dynamotor 220 and the wet gas compressor 230. During start-up, the third clutch 258 can be engaged to communicate the turbine 240 with the wet gas compressor 230 while the first clutch 250 is disengaged. Afterwards, the expander 210 can communicate with the dynamotor 220 and the wet gas compressor 230 by engaging the first clutch 250 and disengaging the third clutch 258 to disconnect the turbine 240. As such, the expander 210 can not only run the wet gas compressor 230 through mechanical linkages, it can also generate electricity via the dynamotor 220. The electricity can be supplied to an electrical grid, as described above.

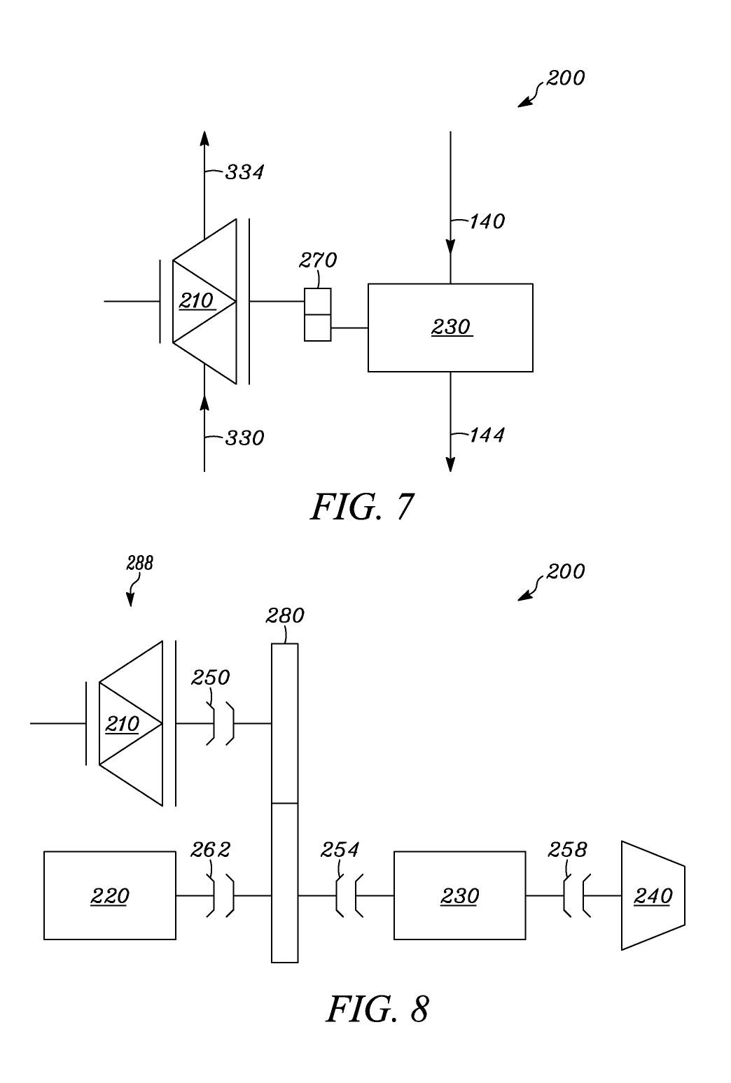

Referring to FIG. 7, a further exemplary version of the fluid transfer device 200 is depicted. In this exemplary device, the expander 210 can communicate with the wet gas compressor 230 via a first gear 270. Thus, the expander 210 can drive the wet gas compressor 230 via mechanical linkages. Gas from the regeneration zone flue gas stream 330 can be communicated around the expander 210 should excessive power be generated.

Referring to FIG. 8 yet a further exemplary version of the fluid transfer device 200 is depicted. In this exemplary embodiment, the expander 210 and the dynamotor 220 may communicate through respective clutches, namely the first clutch 250 and a fourth clutch 262 with the split gear 280. In turn, the split gear 280 can communicate with the wet compressor 230 via the second clutch 254, and the wet gas compressor 230 may, in turn, communicate with the turbine 240 via the third clutch 258. Thus, the expander 210 and the dynamotor 220 can be in a parallel relationship with respect to the wet gas compressor 230 and/or the turbine 240. In this exemplary embodiment during start-up, the turbine 240 can be communicated with the wet gas compressor 230 by engaging the third clutch 258, while the second clutch 254 can disengage the wet gas compressor 230 with the split gear 280. After starting the wet gas compressor 230, the first clutch 250 may be engaged to communicate the expander 210 with the split gear 280, and the third clutch 258 can be disengaged to disrupt the communication of the wet gas compressor 230 with the turbine 240. If excess power is being generated by the expander 210, the fourth clutch 262 can be engaged with the dynamotor 220 to provide electricity to the electrical grid of the refinery or chemical manufacturing plant.

As disclosed herein, the embodiments can provide an opportunity to reduce capital costs and generate additional electricity in a refining or chemical manufacturing plant. Particularly, during a revamp, the expander 210 can be communicated with the wet gas compressor 230 to avoid having to obtain additional energy resources for operating the compressor 230 if, e.g., an expansion is desired. Moreover, electricity can be generated by communicating the expander 210 with the dynamotor 220, and hence, the fluid transfer device 200 can be a net power generator.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A method for revamping a fluid catalytic cracking unit, comprising:
A) communicating an expander powered by a regeneration zone flue gas stream with a wet gas compressor transferring a stream comprising one or more hydrocarbons from a receiver of the fluid catalytic cracking unit.

2. The method according to claim 1, wherein the fluid catalytic cracking unit comprises:
a reaction zone;
a regeneration zone; and
a product separation zone.

3. The method according to claim 2, wherein the reaction zone comprises the receiver.

4. The method according to claim 1, wherein the stream comprises one or more C10⁻ hydrocarbons.

5. The method according to claim 1, further comprising communicating a dynamotor with the expander and wet gas compressor.

6. The method according to claim 5, further comprising interposing at least one of a clutch and a gear between at least one of the expander and the dynamotor, and the dynamotor and wet gas compressor.

7. The method according to claim 6, wherein at least one of the clutch and gear is interposed between the expander and the dynamotor.

8. The method according to claim 6, wherein at least one of the clutch and gear is interposed between the expander and the wet gas compressor.

9. The method according to claim 1, wherein a gear is interposed between the expander and the wet gas compressor.

10. The method according to claim 9, wherein the gear comprises a split gear.

11. A system for operating a wet gas compressor, comprising:
A) an expander receiving a flue gas from a regeneration zone of a fluid catalytic cracking unit; and
B) a wet gas compressor transferring a stream comprising one or more hydrocarbons;
wherein the expander communicates with the wet gas compressor for at least intermittently powering the wet gas compressor.

12. The system according to claim 11, wherein the flue gas has a flow rate of about 150,000-about 300,000 kg/hour.

13. The system according to claim 12, wherein the flue gas enters the expander at a pressure of about 300-about 400 kPa and a temperature of about 640-about 850° C.

14. The system according to claim 13, wherein the flue gas exits the expander at a pressure of about 110-about 140 kPa and a temperature of about 540-about 640° C.

15. The system according to claim 11, wherein the stream comprises one or more C10⁻ hydrocarbons.

16. The system according to claim 11, further comprising a dynamotor communicating with the expander.

17. The system according to claim 16, further comprising at least one of a gear and a clutch between the expander and the wet gas compressor.

18. The system according to claim 16, further comprising at least one of a gear and a clutch between the dynamotor and the wet gas compressor.

19. A system for utilizing a regeneration zone flue gas, comprising:
A) a wet gas compressor;
B) a dynamotor;
C) an expander wherein the expander receives the regeneration zone flue gas for powering at least one of the wet gas compressor and the dynamotor; and
D) a split gear for communicating the expander with the wet gas compressor and the dynamotor.

20. The system according to claim 19, wherein the dynamotor and the wet gas compressor are in a parallel relation with respect to the expander.
